(19) United States
(12) Patent Application Publication
(10) Pub. No.: US 2026/0319504 A1
(43) Pub. Date: Oct. 15, 2026

(54) AUTONOMOUS CHARGING METHOD AND SYSTEM FOR ROBOT

(71) Applicants: Hyundai Motor Company, Seoul (KR); Kia Corporation, Seoul (KR)

(72) Inventor: Seungjoon Lee, Hwaseong-si (KR)

(21) Appl. No.: 19/426,993

(22) Filed: Dec. 19, 2025

(30) Foreign Application Priority Data
Apr. 15, 2025 (KR) 10-2025-0048582

(51) Int. Cl. G05D 1/622; G05D 1/229; G05D 1/43; G05D 1/646

(52) U.S. Cl. CPC G05D 1/622; G05D 1/229; G05D 1/43; G05D 1/646

(57) ABSTRACT

In an embodiment, a method for autonomous charging robot includes detecting sensor data within a field of view of the sensor portion of the robot; detecting, by a controller of the robot, a relative position of a charging station and an obstacle based on the sensor data; determining, by the controller, stopover points based on the relative position of the charging station and the obstacle; determining, by the controller, a final path based on the stopover points and the obstacle; controlling, by the controller, the robot to follow the determined final path; performing docking of the robot based on a distance between the robot and the charging station being less than or equal to a docking start distance; and performing charging of the robot based on completion of the docking of the robot.

### CROSS-REFERENCE TO RELATED APPLICATIONS

This application claims the benefit of and priority to Korean Patent Application No. 10-2025-0048582 filed with the Korean Intellectual Property Office on Apr. 15, 2025, the entire contents of which are incorporated herein by reference.

### TECHNICAL FIELD

The present disclosure relates to an autonomous charging method and an autonomous charging system for a robot.

### BACKGROUND

Use of a mobile robot such as an indoor/outdoor delivery robot, a service robot, or a patrol robot has recently been increasing. Most mobile robots are performing their duties based on an autonomous driving technology.

Because the mobile robot typically performs tasks using electrical energy, an autonomous charging technology is essential for the mobile robot to perform the task autonomously. In particular, a need for an autonomous docking technology that guarantees a high success rate without being affected by a surrounding environment and colliding with an obstacle or the like is emerging. To this end, according to a conventional technology, a method for performing docking of the mobile robot using real-time sensor data (e.g., a relative position of a charging station or the obstacle) without information on the surrounding environment is mainly used.

However, the method for performing the docking by trusting the real-time sensor data as it is may be used only when high reliability of the sensor data is assumed. Therefore, if reliability of a sensor is not secured due to specification of the sensor, the surrounding environment, or the like, it may be difficult to succeed in the docking.

Additionally, according to the conventional technology, if the obstacle exists within a predetermined distance from the mobile robot during the docking, the docking is stopped. However, in this case, the docking may be stopped even by an obstacle unrelated to the docking (e.g., an obstacle disposed in an opposite direction of the mobile robot's direction of progress during the docking), so that a time required for the docking is increased.

The above information disclosed in this Background section is only for enhancement of understanding of the background of this disclosure, and therefore it may include information that does not form the prior art that is already known to a person of ordinary skill in the art.

### SUMMARY

An embodiment of the present disclosure provides an autonomous charging method and an autonomous charging system for a robot capable of stably docking a robot to a charging station even when reliability of sensor data is not high.

An autonomous charging method for a robot according to an embodiment of the present disclosure includes: detecting, by a sensor portion provided in the robot, sensor data within field of view of the sensor portion; detecting, by a controller provided in the robot, a relative position of a charging station and an obstacle based on the sensor data; determining, by the controller, stopover points based on the relative position of the charging station and the obstacle; determining, by the controller, a final path based on the stopover points and the obstacle; controlling, by the controller, the robot to follow the determined final path; performing docking of the robot based on a distance between the robot and the charging station being less than or equal to a docking start distance; and performing charging of the robot based on completion of the docking of the robot.

In an embodiment, determining of the stopover points may include: generating a first stopover point candidate that is a point separated by a first predetermined distance from the charging station; determining whether the first stopover point candidate is occupied by the obstacle; determining the first stopover point candidate as a first stopover point based on the first stopover point candidate not being occupied by the obstacle; generating a second stopover point candidate that is a point separated by a second predetermined distance from the charging station; determining whether the second stopover point candidate is occupied by the obstacle; and determining the second stopover point candidate as a second stopover point based on the second stopover point candidate not being occupied by the obstacle.

In an embodiment, determining of the stopover points may further include transmitting a failure message and terminating the autonomous charging method based on the first stopover point candidate being occupied by the obstacle.

In an embodiment, determining of the stopover points may further include: searching for the second stopover point candidate based on the second stopover point candidate being occupied by the obstacle; and determining the searched second stopover point candidate as the second stopover point.

In an embodiment, searching of the second stopover point candidate may include: determining whether the second stopover point candidate exists in a longitudinal direction; and searching for the second stopover point candidate in a transverse direction based on the second stopover point candidate not existing in the longitudinal direction.

In an embodiment, searching of the second stopover point candidate may further include transmitting a failure message and terminating the autonomous charging method based on the second stopover point candidate not existing in the transverse direction.

In an embodiment, determining of the stopover points may further include: determining whether a third stopover point candidate is required; setting the third stopover point candidate so that a distance between the third stopover point candidate and the first stopover point is a third predetermined distance based on determining that the third stopover point candidate is required; determining whether the third stopover point candidate is occupied by the obstacle; and determining the third stopover point candidate as a third stopover point based on the third stopover point candidate not being occupied by the obstacle.

In an embodiment, determining of the stopover points may further include: searching for the third stopover point candidate based on the third stopover point candidate being occupied by the obstacle; and determining the searched third stopover point candidate as the third stopover point.

In an embodiment, searching of the third stopover point candidate may include: determining whether the third stopover point candidate exists in a longitudinal direction; and searching for the third stopover point candidate in a transverse direction based on the third stopover point candidate not existing in the longitudinal direction.

In an embodiment, searching of the third stopover point candidate may further include transmitting a failure message and terminating the autonomous charging method based on the third stopover point candidate not existing in the transverse direction.

In an embodiment, stopover points may include a first stopover point and a second stopover point from the charging station in order, and the determining of the final path may include generating a first reference path portion from the second stopover point to the first stopover point, determining whether the first reference path portion is occupied by the obstacle, determining a first auxiliary stopover point in a longitudinal direction between the first stopover point and the obstacle based on the first reference path portion being occupied by the obstacle, determining a second auxiliary stopover point in a transverse direction of the first auxiliary stopover point, and determining a first final path portion that sequentially connects the second stopover point, the second auxiliary stopover point, the first auxiliary stopover point, and the first stopover point in a straight line.

In an embodiment, determining of the final path may further include determining the first reference path portion as the first final path portion based on the first reference path portion not being occupied by the obstacle.

In an embodiment, determining of the final path may further include: determining whether a third stopover point exists; generating a second reference path portion from the third stopover point to the second stopover point based on determining that the third stopover point exists; determining whether the second reference path portion is occupied by the obstacle; determining a third auxiliary stopover point in a transverse direction of the obstacle based on the second reference path portion being occupied by the obstacle; determining a second final path portion that sequentially connects the third stopover point, the third auxiliary stopover point, and the second stopover point in a straight line; and determining a third final path portion from a current position of the robot to the third stopover point.

In an embodiment, determining of the final path may further include determining the second reference path portion as the second final path portion based on the second reference path portion not being occupied by the obstacle.

In an embodiment, determining of the final path may further include determining a fourth final path portion from the current position of the robot to the second stopover point based on determining that the third stopover point does not exist.

In an embodiment, following of the final path may include fixing the relative position of the charging station based on reaching a position fixing point.

In an embodiment, relative position of the charging station may be fixed as a moving average value of the relative position of the charging station based on the moving average value at the position fixing point remaining within a set range for a period of time.

In an embodiment, based on the obstacle within a proximity search region of the robot being detected during the following of the final path or the docking of the robot, the following of the final path or the docking of the robot may be stopped.

In an embodiment, the proximity search region may be varied depending on a progress direction of the robot and the distance between the robot and the charging station.

An autonomous charging system for a robot according to an embodiment of the present disclosure includes: a sensor portion that is configured to detect sensor data within a field of view of the sensor portion; and a controller that is configured to receive the sensor data from the sensor portion, detect a relative position of a charging station and an obstacle based on the sensor data, and control movement, docking, or charging of the robot based on the relative position of the charging station and the obstacle. The controller is configured to execute the autonomous charging method of the robot according to the embodiment of the present disclosure.

According to the present disclosure of an embodiment, robustness of autonomous docking may be improved by securing reliability of recognition information of a charging station even when reliability of sensor data is not high.

Additionally, in an embodiment, a possibility of unnecessary docking interruption may be eliminated by selecting an obstacle detection region considering the robot's direction of progress. Accordingly, an efficiency of docking may be improved.

In addition, an effect obtained or predicted by an embodiment of the present disclosure is disclosed directly or implicitly in a detailed description of the present disclosure. That is, various effects predicted according to the present disclosure will be disclosed in the detailed description to be described below.

### BRIEF DESCRIPTION OF THE DRAWINGS

Embodiments of the present specification may be better understood with reference to the following description in connection with the accompanying drawings in which like reference numerals indicate identical or functionally similar elements.

FIG. 1 is a block diagram of an autonomous charging system for a robot according to an embodiment of the present disclosure.

FIG. 2 is a flowchart of an autonomous charging method for a robot according to an embodiment of the present disclosure.

FIG. 3 is a detailed flowchart of a step S120 of FIG. 2.

FIG. 4 is a detailed flowchart of a step S130 of FIG. 2.

FIG. 5 is a detailed flowchart of a step S140 of FIG. 2.

FIG. 6 illustrates an example of determining stopover points and a final path.

FIG. 7 illustrates an example of adjusting a position of the stopover point.

FIG. 8 illustrates an example of determining an auxiliary stopover point and a final path.

FIG. 9 illustrates an example of a proximity search region according to a progress direction of the robot and a distance between the robot and a charging station.

FIG. 10 illustrates an example of a relative position of the charging station with respect to a coordinate system of the robot.

FIG. 11 illustrates an example of a height y and an orientation (θ) of the charging station based on the coordinate system of the robot detected by the robot disposed at a position fixing point.

FIG. 12 illustrates an example of a height y and an orientation (θ) of the charging station based on the coordinate system of the robot of FIG. 11 processed by a moving average method.

FIG. 13 illustrates an example of fixing a position along a transverse direction x and a height y of the charging station based on the robot coordinate system.

The drawings referenced above are not necessarily shown to scale, but should be understood as providing a somewhat simplified representation of various preferred features that illustrate a basic principle of the present disclosure. For example, specific design features of the present disclosure including a specific dimension, a specific direction, a specific position, and a specific shape will be partially determined by a specific intended application and a specific intended usage.

### DETAILED DESCRIPTION OF ILLUSTRATIVE EMBODIMENTS

The terminology used herein is for the purpose of describing particular embodiments only and is not intended to be limiting of the present disclosure. As used herein, singular forms are intended to include plural forms as well unless the context clearly indicates otherwise. It will be further understood that the terms “comprises” and/or “comprising” when used in this specification specify the presence of stated features, integers, steps, operations, elements, and/or components but do not preclude the presence or addition of one or more other features, integers, steps, operations, elements, components, and/or groups thereof. As used herein, the term “and/or” includes any one or all combinations of associated listed items.

The term “robot” or another similar term used in the present specification includes a general robot capable of being moved on land including a passenger car including a sports utility vehicle (SUV), a bus, a truck, various commercial vehicles, or the like, includes a robot capable of moving to the ocean including various boats and ships and a robot capable of moving to the air including an aircraft, a drone, or the like, and includes any object capable of moving by receiving power from a power source. In addition, the term “robot” or the other similar term used in the present specification is understood to include a hybrid power robot, an electric power robot, a plug-in hybrid power robot, a hydrogen power robot, and another alternative fuel robot. For example, the alternative fuel may be a fuel derived from a resource other than petroleum. As stated in the present specification, the hybrid power robot includes a robot having two or more power sources (for example, a gasoline power robot and an electric power robot). The robot according to an embodiment of the present disclosure includes not only a robot that travels somewhat autonomously but also a robot that travels completely autonomously or automatically.

It is understood that one or more of methods below or aspects thereof may be executed by at least one controller. The term “controller” may refer to a hardware device including a memory and a processor. The memory is configured to store program instructions, and the processor is specifically programmed to execute the program instructions in order to perform one or more processes described in more detail below. The controller may control operations of units, modules, parts, devices, or the like, as described herein. It is understood that the methods below may be executed by a device including a controller in conjunction with one or more other components, as will be appreciated by those skilled in the art.

The controller of the present disclosure may be implemented as a non-transitory computer-readable recording medium including executable program instructions executed by a processor. Examples of the computer-readable recording medium include a ROM, a RAM, a compact disk (CD) ROM, magnetic tapes, floppy disks, flash drives, smart cards, and optical data storage devices, but are not limited thereto. The computer-readable recording medium may be distributed throughout a computer network so that the program instructions may be stored and executed in a distributed manner, for example, on a telematics server or a Controller Area Network (CAN).

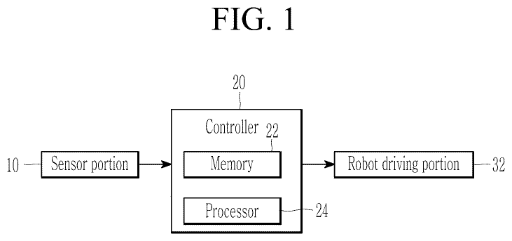

FIG. 1 is a block diagram of an autonomous charging system for a robot according to an embodiment of the present disclosure.

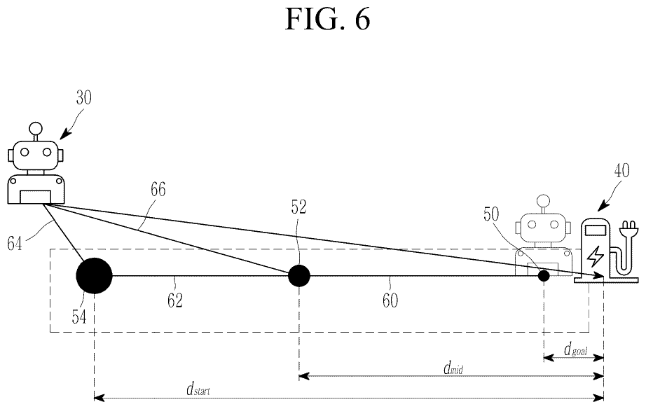

As illustrated in FIG. 1, the autonomous charging system for a robot 30 according to an embodiment of the present disclosure may include a sensor portion 10, a controller 20, and a robot 30 (see FIGS. 6 to 10).

The sensor portion 10 may be installed on the robot 30, and may include any sensor such as a light detection and ranging (LIDAR), a camera, or radio detection and ranging (RADAR) capable of sensing an obstacle within field of view or capable of sensing or determining a relative position of the charging station 40 with respect to the robot 30 (e.g., a position along a transverse direction x, a height y, or an orientation (θ) of the charging station 40 with respect to the robot 30). Here, the obstacle or the term similar thereto may mean an object such as a building, a wall, or a person that may impede movement of the robot 30 or that the robot 30 may not pass through. The obstacle or the term similar thereto may mean an object that occupies a physical space and is within a height of the robot 30. The sensor portion 10 may be connected to transmit data to the controller 20 so that it transmits sensor data detected within field of view to the controller 20.

The controller 20 may receive the sensor data from the sensor portion 10, may generate a path for autonomous driving or autonomous docking of the robot 30 based on the sensor data, and may control the autonomous driving or the autonomous docking of the robot 30 according to the generated path. To this end, the controller 20 may include a memory 22 and one or more processors 24, the memory 22 may store various data and a set program, and the one or more programs may be operated by the set program stored in the memory 22. The set programs may be programmed to perform each step of an autonomous charging method for the robot 30 according to an embodiment of the present disclosure. The controller 20 may include an obstacle detecting portion, a stopover point determining portion, a final path determining portion, a final path following portion, a charging station position fixing portion, a docking performing portion, an emergency stop performing portion, and a charging performing portion.

The obstacle detecting portion may be configured to detect each of obstacles 70, 70a, and 70b based on the sensor data received from the sensor portion 10, and may be configured to transmit information on the detected each of obstacles 70, 70a, and 70b to the stopover point determining portion, the final path determining portion, and/or the emergency stop performing portion. The information on the obstacle may include existence, a type, a position, or the like of the obstacle. The obstacle detection logic for detecting the obstacle from the sensor data may be stored in the obstacle detecting portion, and the obstacle detection logic may be a point cloud and image-based logic, a deep learning-based logic, a sensor fusion-based logic, or the like. The present disclosure is not particularly limited thereto, and an appropriate obstacle detection logic known to those skilled in the art may be used.

The stopover point determining portion may be configured to determine the relative position of the charging station 40 based on the sensor data received from the sensor portion 10, and may be configured to determine stopover points for generating a final path to the charging station 40 based on the relative position of the charging station 40.

FIG. 6 illustrates an example of determining the stopover points and the final path. For example, FIG. 6 shows a method for determining the stopover points and the final path if there is no obstacle between the robot 30 and the charging station 40. As shown in FIG. 6, if the stopover point determining portion determines the relative position of the charging station 40, the stopover point determining portion may determine a position of a first stopover point 50 in front of the charging station 40. The first stopover point 50 may be a final arrival point where a charging port of the robot 30 is docked to the charging station 40, and may be a point away from the charging station 40 by a first predetermined distance d_{goal} in front of the charging station 40. The first predetermined distance d_{goal} may be a radius of the robot 30, but the present disclosure is not limited thereto.

If the position of the first stopover point 50 is determined, the stopover point determining portion may determine a position of a second stopover point 52. The second stopover point 52 may be an essential point required to stabilize position information of the charging station 40. In an example, the stopover point determining portion may set a point at which accuracy of the sensor data is highest as the second stopover point 52. The second stopover point 52 may be set based on specifications of the sensor portion 10 installed on the robot 30, and may be a point separated by a second predetermined distance d_{mid} away from the charging station 40. If the sensor portion 10 includes a lidar sensor, the second predetermined distance d_{mid} may be 1.2 m, but the present disclosure is not limited thereto.

If a position of the second stopover point 52 is determined, the stopover point determining portion may determine whether a third stopover point 54 is necessary. The third stopover point 54 may be an incidental point generated when the second stopover point 52 is too close or too far from the charging station 40 to be difficult to ensure straightness of the robot 30 when the robot 30 enters the charging station 40. In an example, the stopover point determining portion may generate the third stopover point 54 when a distance (d_{mid}−d_{goal}) between the first stopover point 50 and the second stopover point 52 is less than a third predetermined distance. For example, the stopover point determining portion may set a position of the third stopover point 54 so that a distance (dₛₜₐᵣₜ−d_{goal}) between the third stopover point 54 and the first stopover point 50 becomes the third predetermined distance, but the present disclosure is not limited thereto.

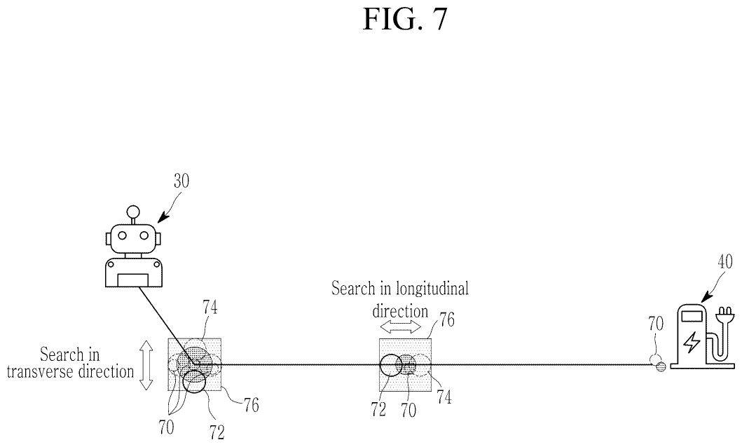

FIG. 7 illustrates an example of adjusting a position of the stopover point. If an obstacle 70 may exist between the robot 30 and the charging station 40, the first, second, and third stopover points 50, 52, and 54 may be generated as the first, second, and third stopover point candidates. In general, because the obstacle 70 may exist between the robot 30 and the charging station 40, the stopover point determining portion may generate the first stopover point candidate instead of the first stopover point 50 by a method of setting the first stopover point 50, may generate the second stopover point candidate instead of the second stopover point 52 by a method of setting the second stopover point 52, and may generate the third stopover point candidate instead of the third stopover point 54 by a method of setting the third stopover point 54.

If the first, second, and third stopover point candidates are generated, as shown in FIG. 7, the stopover point determining portion may check whether an obstacle 70 is disposed at the first, second, and third stopover point candidates. In an example, the stopover point determining portion may first check whether the obstacle 70 is disposed at the first stopover point candidate. For example, the stopover point determining portion may check whether the obstacle 70 is disposed within a predetermined search region 76 centered on the first stopover point candidate. If the obstacle 70 is disposed within the predetermined search region 76 centered on the first stopover point candidate, the stopover point determining portion may determine that docking of the robot 30 is impossible, may transmit a failure message to a control server, a user's mobile device, or the like, and may terminate the autonomous charging method for the robot 30.

If the obstacle 70 is not disposed within the predetermined search region 76 centered on the first stopover point candidate, the stopover point determining portion may determine the first stopover point candidate as the first stopover point 50, and may check whether the obstacle 70 is disposed within the predetermined search region 76 centered on the second stopover point candidate. If the obstacle 70 is disposed within the predetermined search region 76 centered on the second stopover point candidate, the stopover point determining portion may search for whether the second stopover point candidate exists in a longitudinal direction. Here, the longitudinal direction may mean a direction that is consistent with or parallel to a direction (or a reference path direction) from the second stopover point candidate toward the first stopover point 50. As illustrated in FIG. 7, a reference number 72 may be a suitable second stopover point candidate and may be a point disposed in the longitudinal direction of the second stopover point candidate and where the obstacle 70 is not disposed, and a reference number 74 may be an unsuitable second stopover point candidate and may be a point disposed in the longitudinal direction of the second stopover point candidate but where the obstacle 70 is disposed.

If the second stopover point candidate does not exist in the longitudinal direction, the stopover point determining portion may search for whether the second stopover point candidate exists in a transverse direction. Here, the transverse direction may mean a direction perpendicular to the longitudinal direction and parallel to the ground. If the second stopover point candidate does not exist in the transverse direction (this is a very special case), the stopover point determining portion may determine that docking of the robot 30 is impossible, may transmit a failure message to the control server, the user's mobile device, or the like, and may terminate the autonomous charging method for the robot 30.

If the second stopover point candidate exists in the longitudinal direction or the transverse direction, the stopover point determining portion may determine the second stopover point candidate as the second stopover point 52. Thereafter, the stopover point determining portion may determine whether the third stopover point candidate is necessary.

If the third stopover point candidate is not required, the stopover point determining portion may transmit the determined first and second stopover points 50 and 52 to the final path determining portion.

If the third stopover point candidate is required, the stopover point determining portion may generate the third stopover point candidate, and may check whether the obstacle 70 is disposed within the predetermined search region 76 centered on the third stopover point candidate. If the obstacle 70 is disposed within the predetermined search region 76 centered on the third stopover point candidate, the stopover point determining portion may search for whether the third stopover point candidate exists in a longitudinal direction. Here, the longitudinal direction may mean a direction that is consistent with or parallel to a direction (or a reference path direction) from the third stopover point candidate toward the second stopover point 52.

If the third stopover point candidate does not exist in the longitudinal direction, the stopover point determining portion may search for whether the third stopover point candidate exists in a transverse direction. Here, the transverse direction may mean a direction perpendicular to the longitudinal direction and parallel to the ground. If the third stopover point candidate does not exist in the transverse direction (this is a very special case), the stopover point determining portion may determine that docking of the robot 30 is impossible, may transmit a failure message to the control server, the user's mobile device, or the like, and may terminate the autonomous charging method for the robot 30.

If the third stopover point candidate exists in the longitudinal direction or the transverse direction, the stopover point determining portion may determine the third stopover point candidate as the third stopover point 54. Thereafter, the stopover point determining portion may transmit the determined first, second, and third stopover points 50, 52, and 54 to the final path determining portion.

The final path determining portion may be configured to generate a reference path based on the first and second stopover points 50 and 52 or the first, second, and third stopover points 50, 52, and 54 received from the stopover point determining portion. The reference path may include a first reference path portion 56 from the second stopover point 52 to the first stopover point 50. If the third stopover point 54 exists, the reference path may further include a second reference path portion 58 from the third stopover point 54 to the second stopover point 52. Additionally, the final path determining portion may further be configured to determine whether the reference path is occupied by an obstacle. If the reference path is occupied by the obstacle, the final path determining portion may further be configured to determine each of auxiliary stopover points 80, 82, and 84, and may further be configured to determine the final path based on the stopover points 50, 52, and 54 and the auxiliary stopover points 80, 82, and 84.

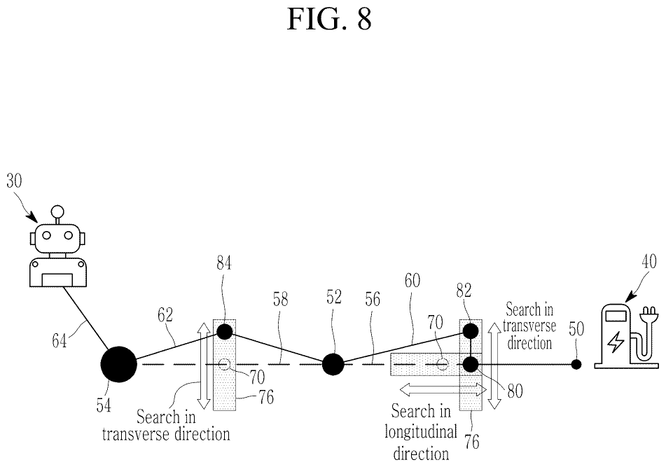

FIG. 8 illustrates an example of determining the auxiliary stopover point and the final path. As shown in FIG. 8, the final path determining portion may generate the first reference path portion 56 that connects the first and second stopover points 50 and 52 in a straight line, and may determine whether the first reference path portion 56 is occupied by the obstacle 70.

If the first reference path portion 56 is not occupied by the obstacle 70, the final path determining portion may determine the first reference path portion 56 as a first final path portion 60.

If the first reference path portion 56 is occupied by the obstacle 70, the final path determining portion may determine the first auxiliary stopover point 80 in a longitudinal direction between the obstacle 70 and the first stopover point 50, and may determine the second auxiliary stopover point 82 in a transverse direction of the first auxiliary stopover point 80. Here, the longitudinal direction may mean a direction of the first reference path portion 56 or a direction parallel to the first reference path portion 56, and the transverse direction may mean a direction perpendicular to the longitudinal direction and parallel to the ground. If the first and second auxiliary stopover points 80 and 82 are determined, the final path determining portion may determine the first final path portion 60 that sequentially connects the second stopover point 52, the second auxiliary stopover point 82, the first auxiliary stopover point 80, and the first stopover point 50 in a straight line.

Thereafter, the final path determining portion may determine whether the third stopover point 54 exists.

If the third stopover point 54 exists, the final path determining portion may generate the second reference path portion 58 that connects the second and third stopover points 52 and 54 in a straight line, and may determine whether the second reference path portion 58 is occupied by the obstacle 70.

If the second reference path portion 58 is not occupied by the obstacle 70, the final path determining portion may determine the second reference path portion 58 as a second final path portion 62. If the second reference path portion 58 is occupied by the obstacle 70, the final path determining portion may determine the third auxiliary stopover point 84 in a transverse direction of the obstacle 70. Here, the longitudinal direction may mean a direction of the second reference path portion 58 or a direction parallel to the second reference path portion 58, and the transverse direction may mean a direction perpendicular to the longitudinal direction and parallel to the ground. If the third auxiliary stopover point 84 is determined, the final path determining portion may determine the second final path portion 62 that sequentially connects the third stopover point 54, the third auxiliary stopover point 84, and the second stopover point 52 in a straight line. Thereafter, the final path determining portion may determine the third final path portion 64 from a current position of the robot 30 to the third stopover point. The final path determining portion may store various algorithms that generate a path that avoids an obstacle from the current position of the robot 30 to a destination. Because the various algorithms are well known to those skilled in the art, a description thereof will be omitted.

If the third stopover point 54 does not exist, the final path determining portion may determine a fourth final path portion 66 from the current position of the robot 30 to the second stopover point 52.

Thereafter, the final path determining portion may transmit the determined final path to the final path following portion. The final path may include the first final path portion 60 and the fourth final path portion 66. If the third stopover point 54 exists, the final path may further include the second and third final path portions 62 and 64.

The final path following portion may control driving and steering of the robot 30 so that the robot 30 follows the final path received from the final path determining portion.

If the robot 30 follows the final path to reach a position fixing point, the charging station position fixing portion may be configured to fix the relative position of the charging station 40 with respect to a coordinate system of the robot. In general, a specific sensor portion 10 such as LIDAR may not have accurate short-range data. Thus, as the sensor portion 10 approaches the charging station 40, reliability of sensor data of the sensor portion 10 may be decreased so that it is difficult to perform the docking. To solve this, if the robot 30 reaches the position fixing point (typically, the position fixing point corresponds to the second stopover point 52 but the present disclosure is not limited thereto), the robot 30 may stay at the position fixing point for a certain period of time, and may collect and process the sensor data to fix the relative position of the charging station 40 with respect to the robot coordinate system with high reliability. Thereafter, the robot 30 may perform the docking based on the relative position of the charging station 40 with respect to the fixed robot coordinate system instead of real-time sensor data.

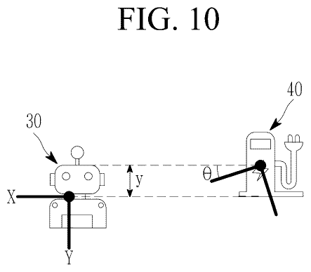

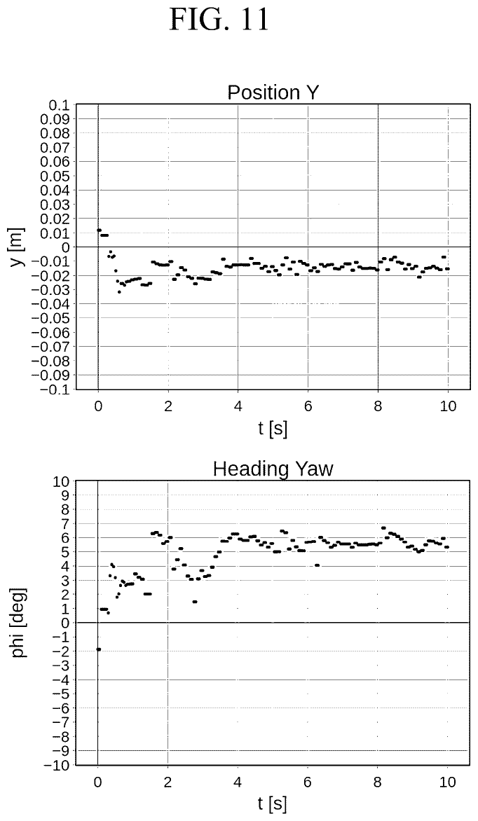

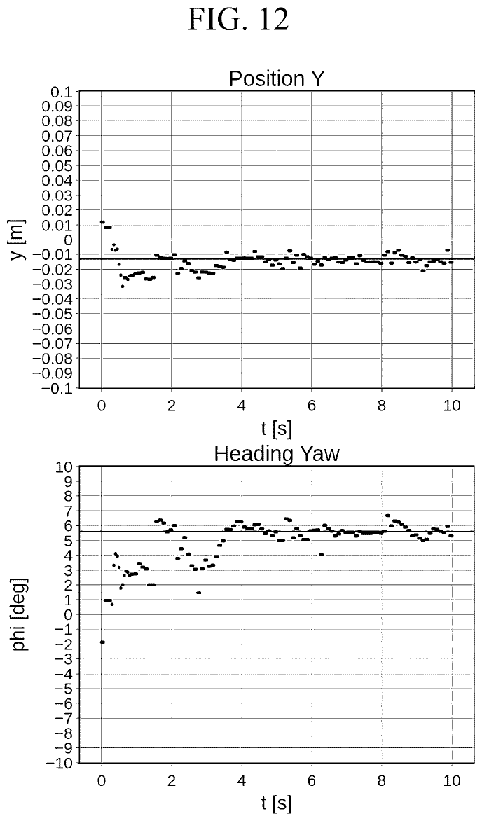

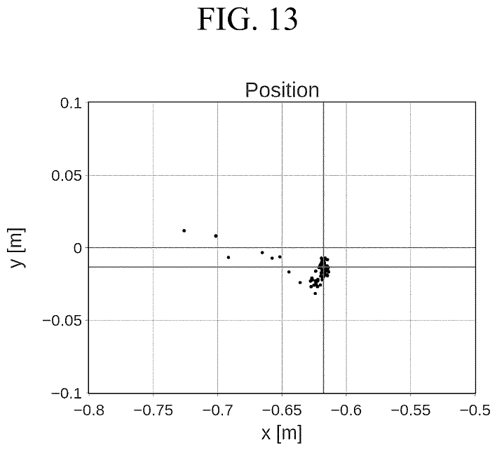

FIG. 10 illustrates an example of the relative position of the charging station with respect to the robot coordinate system, FIG. 11 illustrates an example of the height y and the orientation (θ) of the charging station based on the robot coordinate system detected by the robot disposed at the position fixing point, FIG. 12 illustrates an example of the height y and the orientation (θ) of the charging station based on the robot coordinate system of FIG. 11 processed by a moving average method, and FIG. 13 illustrates an example of fixing the position along the transverse direction x and the height y of the charging station based on the robot coordinate system.

In order to perform the docking of the robot 30, the position along the transverse direction x, the height y, and the orientation (θ) of the charging station 40 with respect to the robot 30 may be important. Accordingly, as illustrated in FIGS. 10 to 13, the relative position of the charging station 40 with respect to the robot coordinate system may include at least the position along the transverse direction x, the height y, and the orientation (θ) of the charging station 40 with respect to the robot 30. For convenience of description, a method for fixing the height y and the orientation (θ) of the charging station 40 is described in FIGS. 10 to 12, but a person skilled in the art should understand that the position along the transverse direction x of the charging station 40 is also fixed in the same manner.

As illustrated in FIG. 10, if the robot 30 reaches the position fixing point, the sensor portion 10 may begin to detect the position along the transverse direction x, the height y, and the orientation (θ) of the charging station 40 with respect to the robot coordinate system X and Y. For example, as shown in FIG. 11, the robot 30 may detect the position along the transverse direction x, the height y, and the orientation (θ) of the charging station 40 with respect to the robot coordinate system X and Y for a certain period of time, and as shown in FIG. 12, the detected position along the transverse direction x, height y, and orientation (θ) of the charging station 40 with respect to the robot coordinate system X and Y may be processed using the moving average method. Detection of the position along the transverse direction x, the height y, and the orientation (θ) of the charging station 40 with respect to the robot coordinate system X and Y may continue until their moving average value stays within a set range for a set period of time (e.g., about 2 seconds). Thereafter, as shown in FIG. 13, the position along the transverse direction x, the height y, and the orientation (θ) of the charging station 40 with respect to the robot coordinate system X and Y may be fixed as the moving average value. For example, in the example of FIG. 13, (x, y) and θ may be respectively as follows.

(x, y)=(−0.62, −0.015), and θ=5.6°

If the relative position of the charging station 40 with respect to the robot coordinate system is fixed, the charging station position fixing portion may transfer the relative position of the charging station 40 with respect to the fixed robot coordinate system to the docking performing portion, and the docking performing portion may be configured to perform the docking based on the relative position of the charging station 40 with respect to the fixed robot coordinate system instead of real-time sensor data. That is, if the relative position of the charging station 40 with respect to the robot coordinate system is fixed, the docking performing portion may perform the docking (only) along the relative position of the charging station 40 with respect to the fixed robot coordinate system.

If an obstacle 70a within each of proximity search regions 78a, 78b, and 78c is detected while the robot 30 follows the final path or performs the docking, the emergency stop performing portion may be configured to stop following the final path or performing docking. That is, if the obstacle 70a within each of the proximity search regions 78a, 78b, and 78c that may interfere with the following of the final path or the performing of the docking is detected, the emergency stop performing portion may urgently stop an operation of the robot 30. Each of the proximity search regions 78a, 78b, and 78c in which there may be the obstacle 70a that may interfere with the following of the final path or the performing of the docking may be varied depending on a direction of progress of the robot 30 and a distance between the robot 30 and the charging station 40.

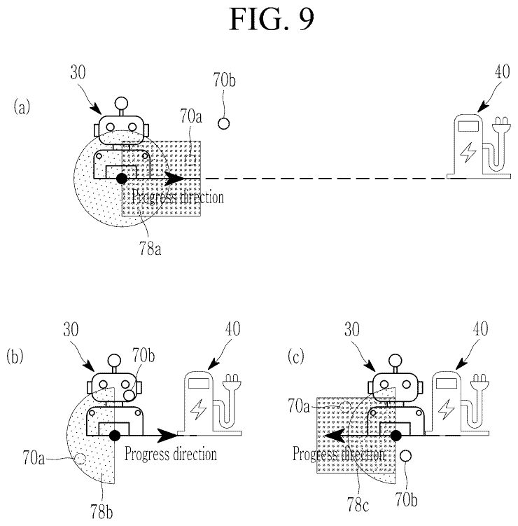

FIG. 9 illustrates an example of the proximity search region according to the progress direction of the robot and the distance between the robot and the charging station.

As shown in FIG. 9 (a), when the distance between the robot 30 and the charging station 40 is longer than a fourth predetermined distance and the robot 30 moves toward the charging station 40, a first proximity search region 78a may be set as a combination of a first setting region in front of the robot 30 in the progress direction and a second setting region centered on the robot 30. Here, the fourth predetermined distance may be the distance between the position fixing point and the charging station 40, but the present disclosure is not limited thereto. For example, the first setting region may have a rectangular parallelepiped shape with a set length, a set width, and a set height set forward from the robot 30 in the progress direction, and the second setting region may have a cylindrical shape having a radius set centered on the robot 30, but the first and second setting regions are not limited thereto. In this example, because an obstacle 70b is disposed forward in the progress direction of the robot 30 but is not disposed within the first proximity search region 78a, the obstacle 70b may not correspond to an obstacle that starts an emergency stop.

As shown in FIG. 9 (b), when the distance between the robot 30 and the charging station 40 is less than or equal to the fourth predetermined distance and the robot 30 moves toward the charging station 40, a second proximity search region 78b may be set as a third setting region disposed backward in the progress direction of the robot 30. For example, the third setting region may have a semi-cylindrical shape having a radius set around the robot 30 and a height set backward (only) in the progress direction of the robot 30, but the third setting region is not limited thereto. In this example, because an obstacle 70b is disposed forward in the progress direction of the robot 30 but is not disposed within the second proximity search region 78b, the obstacle 70b may not correspond to an obstacle that starts an emergency stop.

As shown in FIG. 9 (c), when the robot 30 moves away from the charging station 40, a third proximity search region 78c may be set as a combination of a fourth setting region in front of the robot 30 in the progress direction and a fifth setting region in front of the robot 30 in the progress direction. For example, the fourth setting region may have a rectangular parallelepiped shape with a set length, a set width, and a set height set forward from the robot 30 in the progress direction, and the fifth setting region may have a semi-cylindrical shape having a radius set around the robot 30 and a height set forward (only) in the progress direction of the robot 30, but the fourth and fifth setting regions are not limited thereto. In this example, because an obstacle 70b is disposed backward in the progress direction of the robot 30 and is not disposed within the third proximity search region 78c, the obstacle 70b may not correspond to an obstacle that starts an emergency stop.

If the docking of the robot 30 to the charging station 40 is completed, the charging performing portion may perform charging of the robot 30. The charging performing portion may charge the robot 30 using at least one appropriate method among various methods for charging the robot 30, and the various methods for charging the robot 30 may be stored in advance in the charging performing portion.

The robot 30 may include at least an energy storage device and a robot driving portion 32, and the robot driving portion 32 may receive electric power from the energy storage device under control of the controller 20 to drive the robot 30 so that the robot 30 follows a path. The robot driving portion 32 may include at least one wheel and at least one driving motor connected to the at least one wheel to rotate the at least one wheel, but the present disclosure is not limited thereto. The robot driving portion 32 may further include a corner module including a steering device for steering the robot 30 and a suspension device for elastically supporting the robot 30 by connecting the robot driving portion 32 to a main body of the robot 30.

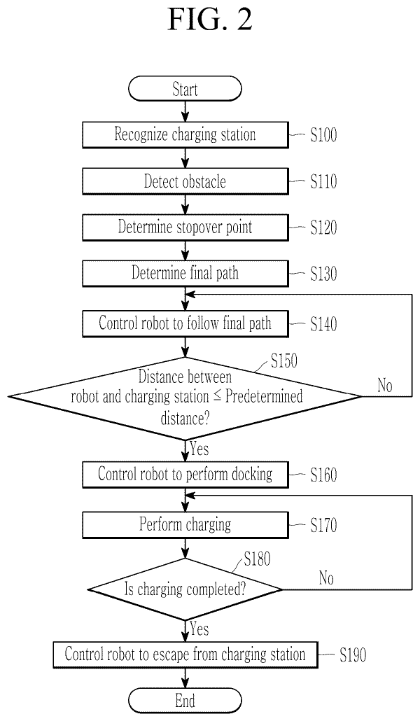

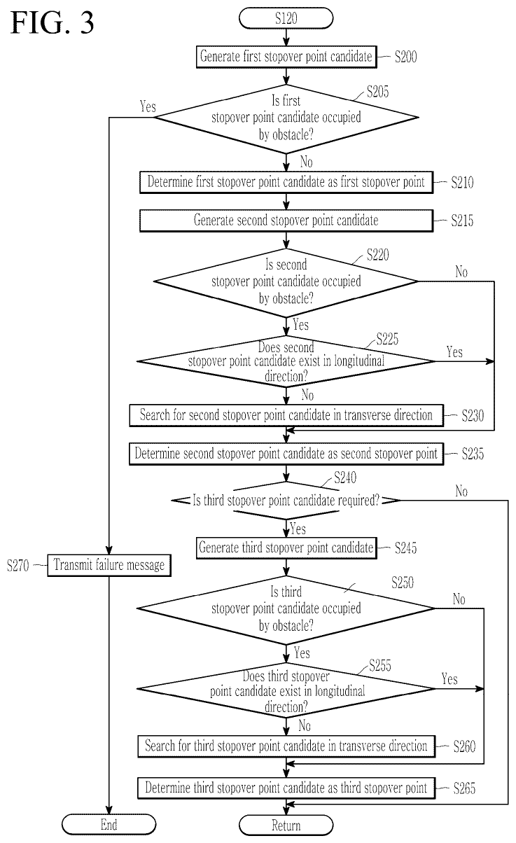

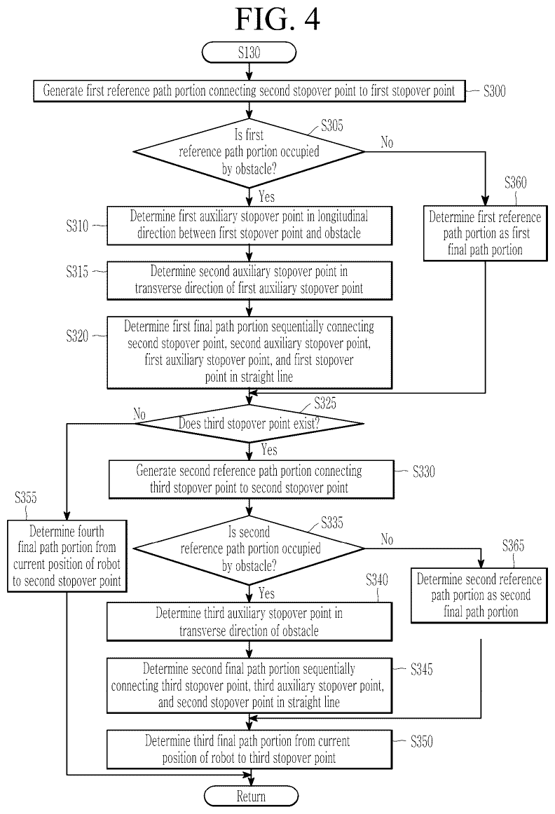

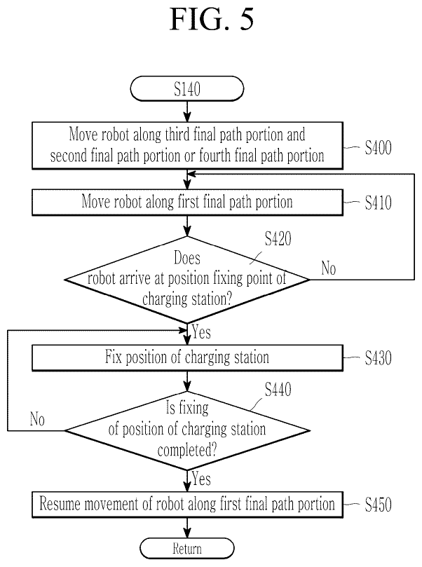

Hereinafter, with reference to FIGS. 2 to 5, the autonomous charging method for the robot according to an embodiment of the present disclosure will be described. FIG. 2 is a flowchart of the autonomous charging method for the robot according to an embodiment of the present disclosure, FIG. 3 is a detailed flowchart of a step S120 of FIG. 2, FIG. 4 is a detailed flowchart of a step S130 of FIG. 2, and FIG. 5 is a detailed flowchart of a step S140 of FIG. 2.

As illustrated in FIG. 2, the autonomous charging method for the robot 30 according to the embodiment of the present disclosure may begin at a step S100. To perform the step S100, the sensor portion 10 may detect sensor data within field of view, and may transmit the detected sensor data to the controller 20.

The controller 20 may recognize a position of the charging station 40 based on the sensor data received from the sensor portion 10, and may determine the relative position of the charging station 40 (S100). In addition, the controller 20 may detect each of the obstacles 70, 70a, and 70b within field of view of the sensor portion 10 based on the sensor data received from the sensor portion 10 (S110).

If the charging station 40 and/or the obstacles 70, 70a, and 70b are recognized, the controller 20 may determine stopover points (or transit points) that the robot 30 should pass through while the robot 30 moves to the charging station 40 (S120).

For example, as illustrated in FIG. 3, the controller 20 may first generate the first stopover point candidate to determine the stopover points (S200). For example, the first stopover point candidate may be a final arrival point where a charging port of the robot 30 is docked to the charging station 40, and may be a point away from the charging station 40 by the first predetermined distance d_{goal} in front of the charging station 40.

If the first stopover point candidate is generated, the controller 20 may determine whether the first stopover point candidate is occupied by the obstacle 70 (S205). For example, the controller 20 may check whether the obstacle 70 is disposed within the predetermined search region 76 centered on the first stopover point candidate.

If the obstacle 70 is disposed within the predetermined search region 76 centered on the first stopover point candidate, the stopover point determining portion may determine that docking of the robot 30 is impossible, may transmit a failure message to the control server, the user's mobile device, or the like (S270), and may terminate the autonomous charging method for the robot 30.

If the obstacle 70 is not disposed within the predetermined search region 76 centered on the first stopover point candidate, the controller 20 may determine the first stopover point candidate as the first stopover point 50 (S210), and may generate the second stopover point candidate (S215). For example, the controller 20 may set a point at which accuracy of the sensor data is highest as the second stopover point candidate. The second stopover point candidate may be set based on the specifications of the sensor portion 10 installed on the robot 30, and may be a point separated by disposed the second predetermined distance d_{mid} away from the charging station 40.

Thereafter, the controller 20 may determine whether the second stopover point candidate is occupied by the obstacle 70 (S220). For example, the controller 20 may check whether the obstacle 70 is disposed within the predetermined search region 76 centered on the second stopover point candidate.

If the second stopover point candidate is occupied by the obstacle 70, the controller 20 may determine whether the second stopover point candidate exists in a longitudinal direction (S225). Here, the longitudinal direction may mean a direction that is consistent with or parallel to the reference path.

If the second stopover point candidate exists in the longitudinal direction, the controller 20 may determine the second stopover point candidate as the second stopover point 52 (S235). If the second stopover point candidate does not exist in the longitudinal direction, the controller 20 may search for the second stopover point candidate in a transverse direction (S230). Here, the transverse direction may mean a direction perpendicular to the longitudinal direction and parallel to the ground.

If the second stopover point candidate does not exist in the transverse direction (this is a very special case), the controller 20 may determine that docking of the robot 30 is impossible, may transmit a failure message to the control server, the user's mobile device, or the like (S270), and may terminate the autonomous charging method for the robot 30.

If the second stopover point candidate exists in the transverse direction, the controller 20 may determine the second stopover point candidate as the second stopover point 52 (S235).

If the second stopover point candidate is not occupied by the obstacle 70, the controller 20 may determine the second stopover point candidate as the second stopover point 52 (S235).

If the second stopover point 52 is determined, the controller 20 may determine whether the third stopover point candidate is required (S240). The third stopover point candidate may be an incidental point generated when the second stopover point 52 is too close or too far from the charging station 40 to be difficult to ensure straightness of the robot 30 when the robot 30 enters the charging station 40. If the third stopover point candidate is not required, the controller 20 may store the first and second stopover points 50 and 52, may terminate the step S120, and may perform the step S130.

If the third stopover point candidate is required, the controller 20 may generate the third stopover point candidate (S245). For example, the controller 20 may set the third stopover point candidate so that a distance (d_{mid}−d_{goal}) between the third stopover point candidate and the first stopover point 50 becomes the third predetermined distance.

If the third stopover point candidate is generated, the controller 20 may determine whether the third stopover point candidate is occupied by the obstacle 70 (S250). For example, the controller 20 may check whether the obstacle 70 is disposed within the predetermined search region 76 centered on the third stopover point candidate.

If the third stopover point candidate is occupied by the obstacle 70, the controller 20 may determine whether the third stopover point candidate exists in a longitudinal direction (S255). Here, the longitudinal direction may mean a direction that is consistent with or parallel to the reference path.

If the third stopover point candidate exists in the longitudinal direction, the controller 20 may determine the third stopover point candidate as the third stopover point 54 (S265). If the third transit point candidate does not exist in a longitudinal direction, the controller 20 may search for the third stopover point candidate in a transverse direction (S260). Here, the transverse direction may mean a direction perpendicular to the longitudinal direction and parallel to the ground.

If the third stopover point candidate does not exist in the transverse direction (this is a very special case), the controller 20 may determine that docking of the robot 30 is impossible, may transmit a failure message to the control server, the user's mobile device, or the like (S270), and may terminate the autonomous charging method for the robot 30.

If the third stopover point candidate exists in the transverse direction, the controller 20 may determine the third stopover point candidate as the third stopover point 54 (S265).

If the third stopover point candidate is not occupied by the obstacle 70, the controller 20 may determine the third stopover point candidate as the third stopover point 54 (S265).

Thereafter, the controller 20 may store the first, second, and third stopover points 50, 52, and 54, may terminate the step S120, and may perform the step S130.

Referring back to FIG. 2, the controller 20 may determine the final path based on the stopover points determined in the step S120 (S130).

For example, as illustrated in FIG. 4, in order to determine the final path, the controller 20 may first generate the first reference path portion 56 that connects the second stopover point 52 to the first stopover point 50 in a straight line (S300), and may determine whether the first reference path portion 56 is occupied by the obstacle 70 (S305).

If the first reference path portion 56 is not occupied by the obstacle 70, the controller 20 may determine the first reference path portion 56 as the first final path portion 60 (S360).

If the first reference path portion 56 is occupied by the obstacle 70, the controller 20 may determine the first auxiliary stopover point 80 in a longitudinal direction between the first stopover point 50 and the obstacle (S310), and may determine the second auxiliary stopover point 82 in a transverse direction of the first auxiliary stopover point 80 (S315). Here, the longitudinal direction may mean a direction of the first reference path portion 56 or a direction parallel to the first reference path portion 56, and the transverse direction may mean a direction perpendicular to the longitudinal direction and parallel to the ground.

If the first and second auxiliary stopover points 80 and 82 are determined, the controller 20 may determine the first final path portion 60 that sequentially connects the second stopover point 52, the second auxiliary stopover point 82, the first auxiliary stopover point 80, and the first stopover point 50 in a straight line (S320).

Thereafter, the controller 20 may determine whether the third stopover point 54 exists (S325).

If the third stopover point 54 exists, the controller 20 may generate the second reference path portion 58 connecting the third stopover point 54 to the second stopover point 52 in a straight line (S330), and may determine whether the second reference path portion 58 is occupied by the obstacle 70 (S335).

If the second reference path portion 58 is not occupied by the obstacle 70, the controller 20 may determine the second reference path portion 58 as the second final path portion 62 (S365).

If the second reference path portion 58 is occupied by the obstacle 70, the controller 20 may determine the third auxiliary stopover point 84 in a transverse direction of the obstacle 70 (S340). Here, the longitudinal direction may mean a direction of the second reference path portion 58 or a direction parallel to the second reference path portion 58, and the transverse direction may mean a direction perpendicular to the longitudinal direction and parallel to the ground.

If the third auxiliary stopover point 84 is determined, the controller 20 may determine the second final path portion 62 that sequentially connects the third stopover point 54, the third auxiliary stopover point 84, and the second stopover point 52 in a straight line (S345). Thereafter, the controller 20 may determine the third final path portion 64 from a current position of the robot 30 to the third stopover point 54 (S350).

If the third stopover point 54 does not exist in a step S325, the controller 20 may determine the fourth final path portion 66 from the current position of the robot 30 to the second stopover point 52 (S355).

Thereafter, the controller 20 may store the determined final path, may terminate the step S130, and may perform the step S140. The final path may include the first final path portion 60 and the fourth final path portion 66. If the third stopover point 54 exists, the final path may further include the second and third final path portions 62 and 64.

Referring back to FIG. 2, the controller 20 may control the robot 30 to follow the determined final path (S140).

For example, as illustrated in FIG. 5, the controller 20 may move the robot 30 along the third final path portion 64 and the second final path portion 62 or the fourth final path portion 66 to the second stopover point 52 (S400), and may move the robot 30 again along the first final path portion 60 (S410). During performing of the steps S400 and S410, the controller 20 may determine whether the robot 20 arrives at the position fixing point (S420). The position fixing point may correspond to the second stopover point 52, but the present disclosure is not limited thereto.

If the robot 30 does not reach the position fixing point, the controller 20 may perform the step S410 to continue to move the robot 30 along the first final path portion 60. However, it should be understood that the controller 20 may perform the step S400 instead of the step S410 if the position fixing point is disposed at the second, third, or fourth final path portions 62, 64, and 66.

If the robot 30 reaches the position fixing point, the robot 30 may stay at the position fixing point for a certain period of time, and may begin to fix a relative position of the charging station 40 with respect to the robot coordinate system (S430).

Thereafter, the controller 20 may determine whether fixing of the relative position of the charging station 40 is completed (S440). That is, the controller 20 may determine whether a moving average value of the position along the transverse direction x, the height y, and the orientation (θ) of the charging station 40 with respect to the robot coordinate system X and Y remains within a set range for a set period of time (e.g., about 2 seconds).

If the fixing of the relative position of the charging station 40 is not completed, the controller 20 may return to a step S430 to continue to fix the relative position of the charging station 40. In contrast, if the fixing of the relative position of the charging station 40 is completed, the controller 20 may resume movement of the robot 30 along the first final path portion 60 (S450), and may end the step S140.

Referring back to FIG. 2, while the robot 30 follows the final path, the controller 20 may determine whether a distance between the robot 30 and the charging station 40 is less than or equal to a predetermined docking start distance (S150). Here, the docking start distance may be the second predetermined distance d_{mid}, but the present disclosure is not limited thereto.

If the distance between the robot 30 and the charging station 40 exceeds the fourth predetermined distance, the controller 20 may return to the step S140 to continue to control the robot 30 to follow the final path.

If the distance between the robot 30 and the charging station 40 is less than or equal to the fourth predetermined distance, the controller 20 may control the robot 30 to perform the docking based on a relative position of the fixed charging station 40 (S160).

If docking of the robot 30 is completed, the controller 20 may charge the robot 30 (S170), and may determine whether the charging is completed (S180).

If the charging is not completed, the controller 20 may return to a step S170 to continue to charge the robot 30, and if the charging is completed, the controller 20 may control the robot 30 to escape from the charging station 40 (S190). Thereafter, the autonomous charging method for the robot 30 according to an embodiment of the present disclosure may be terminated.

If the obstacle 70a within the first, second, and third proximity search regions 78a, 78b, and 78c is detected while the robot 30 follows the final path or performs the docking, the controller 20 may stop the following of the final path or the performing of the docking. That is, if the obstacle 70a within the first, second, and third proximity search regions 78a, 78b, and 78c that may interfere with the following of the final path or the performing of the docking is detected, the controller 20 may urgently stop an operation of the robot 30. The first, second, and third proximity search regions 78a, 78b, and 78c may be varied depending on a direction of progress of the robot 30 and a distance between the robot 30 and the charging station 40.

For example, when the distance between the robot 30 and the charging station 40 is longer than the fourth predetermined distance and the robot 30 moves toward the charging station 40, the first proximity search region 78a may be set as a combination of the first setting region in front of the robot 30 in the progress direction and the second setting region centered on the robot 30.

When the distance between the robot 30 and the charging station 40 is less than or equal to the fourth predetermined distance and the robot 30 moves toward the charging station 40, the second proximity search region 78b may be set as the third setting region disposed backward in the progress direction of the robot 30.

When the robot 30 moves away from the charging station 40, the third proximity search region 78c may be set as a combination of the fourth setting region in front of the robot 30 in the progress direction and the fifth setting region in front of the robot 30 in the progress direction.

While this disclosure has been described in connection with what is presently considered to be practical embodiments, it should be understood that the disclosure is not limited to the disclosed embodiments, but, on the contrary, is intended to cover various modifications and equivalent arrangements included within the spirit and scope of the appended claims.

What is claimed is:

1. A method for autonomous charging a robot, the method comprising:
detecting, by a sensor portion of the robot, sensor data within a field of view of the sensor portion, wherein the sensor portion comprises one or more sensors;
detecting, by a controller of the robot, a relative position of a charging station and an obstacle based on the sensor data, wherein the relative position includes distance information from the charging station and the obstacle to the robot;
determining, by the controller, stopover points based on the relative position of the charging station and the obstacle;
determining, by the controller, a final path based on the stopover points and the obstacle;
controlling, by the controller, the robot to follow the determined final path;
performing docking of the robot based on a distance between the robot and the charging station being less than or equal to a docking start distance; and
performing charging of the robot based on completion of the docking of the robot.

2. The method of claim 1, wherein determining the stopover points comprises:
generating a first stopover point candidate that is a point separated by a first predetermined distance from the charging station;
determining whether the first stopover point candidate is occupied by the obstacle;
determining the first stopover point candidate as a first stopover point based on the first stopover point candidate not being occupied by the obstacle;
generating a second stopover point candidate that is a point separated by a second predetermined distance from the charging station;
determining whether the second stopover point candidate is occupied by the obstacle; and
determining the second stopover point candidate as a second stopover point based on the second stopover point candidate not being occupied by the obstacle.

3. The method of claim 2, wherein determining the stopover points further comprises transmitting a failure message and canceling autonomous charging of the robot based on the first stopover point candidate being occupied by the obstacle.

4. The method of claim 2, wherein determining the stopover points further comprises:
searching the second stopover point candidate based on previously searched second stopover point candidate being occupied by the obstacle; and
determining the searched second stopover point candidate as the second stopover point.

5. The method of claim 4, wherein searching the second stopover point candidate comprises:
determining whether the second stopover point candidate exists in a longitudinal direction; and
searching for the second stopover point candidate in a transverse direction based on the second stopover point candidate not existing in the longitudinal direction.

6. The method of claim 5, wherein searching the second stopover point candidate further comprises transmitting a failure message and canceling autonomous charging of the robot based on the second stopover point candidate not existing in the transverse direction.

7. The method of claim 4, wherein determining the stopover points further comprises:
determining whether a third stopover point candidate is required;
setting the third stopover point candidate so that a distance between the third stopover point candidate and the first stopover point is a third predetermined distance based on determining that the third stopover point candidate is required;
determining whether the third stopover point candidate is occupied by the obstacle; and
determining the third stopover point candidate as a third stopover point based on the third stopover point candidate not being occupied by the obstacle.

8. The method of claim 7, wherein determining the stopover points further comprises:
searching for the third stopover point candidate based on the third stopover point candidate being occupied by the obstacle; and
determining the searched third stopover point candidate as the third stopover point.

9. The method of claim 8, wherein searching the third stopover point candidate comprises:
determining whether the third stopover point candidate exists in a longitudinal direction; and
searching for the third stopover point candidate in a transverse direction based on the third stopover point candidate not existing in the longitudinal direction.

10. The method of claim 9, wherein searching the third stopover point candidate further comprises transmitting a failure message and canceling autonomous charging of the robot based on the third stopover point candidate not existing in the transverse direction.

11. The method of claim 1, wherein controlling the robot to follow the final path comprises fixing the relative position of the charging station based on reaching a position fixing point.

12. The method of claim 11, wherein the relative position of the charging station is fixed as a moving average value of the relative position of the charging station based on the moving average value at the position fixing point remaining within a set range for a period of time.

13. The method of claim 1, wherein controlling the robot to follow the final path or docking of the robot is stopped based on the obstacle within a proximity search region of the robot being detected during the robot following the final path or docking the robot.

14. The method of claim 13, wherein the proximity search region is varied depending on a progress direction of the robot and the distance between the robot and the charging station.

15. An autonomous charging system, the system comprising:
a charging station; and
a robot comprising:
a sensor portion configured to detect sensor data within a field of view of the sensor portion, wherein the sensor portion comprises one or more sensors; and
a controller configured to:
receive the sensor data from the sensor portion;
detect a relative position of the charging station and an obstacle based on the sensor data, wherein the relative position comprises distance information from the charging station to the robot;
determine stopover points based on the relative position of the charging station and the obstacle;
determine a final path based on the stopover points and the obstacle;
control the robot to follow the determined final path;
perform docking the robot based on a distance between the robot and the charging station being less than or equal to a docking start distance; and
charge the robot after docking the robot is completed.

16. A robot comprising:
a sensor configured to collect and transmit a sensor data, wherein the sensor data comprises position information of an obstacle and a charging station detected by the sensor;
a controller configured to:
receive the sensor data from the sensor and store in a memory, wherein the memory comprises executable program instructions;
detect a relative position of a charging station and an obstacle based on the sensor data, wherein the relative position comprises distance information from the charging station to the robot;
determine a first stopover point, and subsequently determine a second stopover point, wherein the first stopover point is away from the charging station by a first distance, and the second stopover point is away from the charging station by a second distance;
determine whether a first reference path portion is occupied by the obstacle, wherein the first reference path portion is a path from the second stopover point to the first stopover point;
determine, based on the first reference path portion being occupied by the obstacle, a first auxiliary stopover point in a longitudinal direction between the first stopover point and the obstacle, and determine a second auxiliary stopover point in a transverse direction of the first auxiliary stopover point;
determine a final path based on the first stopover point, second stopover point, and the obstacle;
control the robot to follow the determined final path;
perform docking the robot based on a distance between the robot and the charging station being less than or equal to a docking start distance; and
charge the robot after docking the robot is completed.

17. The robot of claim 16, wherein the controller is configured to determine the final path by determining a first final path portion that sequentially connects the second stopover point, the second auxiliary stopover point, the first auxiliary stopover point, and the first stopover point by straight line segments, and by determining the first reference path portion as the first final path portion based on the first reference path portion not being occupied by the obstacle.

18. The robot of claim 17, wherein the controller is further configured to:
determine whether a third stopover point exists;
generate a second reference path portion from the third stopover point to the second stopover point based on determining that the third stopover point exists;
determine whether the second reference path portion is occupied by the obstacle;
determine a third auxiliary stopover point in a transverse direction of the obstacle based on the second reference path portion being occupied by the obstacle;
determine a second final path portion that sequentially connects the third stopover point, the third auxiliary stopover point, and the second stopover point in a straight line; and
determine a third final path portion from a current position of the robot to the third stopover point.

19. The robot of claim 18, wherein the controller is further configured to determine the second reference path portion as the second final path portion based on the second reference path portion not being occupied by the obstacle.

20. The robot of claim 18, wherein the controller is further configured to determine a fourth final path portion from the current position of the robot to the second stopover point based on determining that the third stopover point does not exist.
